(19) United States
(12) Patent Application Publication
(10) Pub. No.: US 2011/0168315 A1
(43) Pub. Date: Jul. 14, 2011

(54) Bicycle Tire

(75) Inventor: Yves Potin, Clermont-Ferrand (FR)

(73) Assignees: SOCIETE DE TECHNOLOGIE MICHELIN, Clermont-Ferrand (FR); Michelin Recherche et Technique S.A., Granges-Paccot (CH)

(21) Appl. No.: 13/002,261

(22) PCT Filed: Feb. 26, 2010
(86) PCT No.: PCT/EP2010/052476

§ 371 Date: Mar. 28, 2011

(30) Foreign Application Priority Data
Mar. 4, 2009 (FR) 0951363

(51) Int. Cl. B60C 15/04

(52) U.S. Cl. 152/540

(57) ABSTRACT

A bicycle tire comprising a carcass reinforcement, each edge of which is anchored in two beads by a turn-up around a bead core, each bead being continued radially by sidewalls which lead into a tread. Each of the bead cores is formed by winding a saturated non-wrapped metal cable made of filaments, the diameter of said cable being less than 1.5 mm and the diameter of the filaments being less than 0.25 mm.

The invention relates to a tire designed to be fitted to a vehicle and more particularly designed to be fitted to a two-wheeled vehicle such as a bicycle.

Bicycle tires usually consist of a layer of carcass reinforcement anchored in two beads by being turned up around two bead cores. The beads are continued radially by sidewalls which are themselves continued by the tread.

The longitudinal direction of the tire, or circumferential direction, is the direction corresponding to the perimeter of the tire and defined by the rolling direction of the tire.

A circumferential plane or circumferential section plane is a plane perpendicular to the axis of rotation of the tire. The equatorial plane is the circumferential plane passing through the centre or crown of the tread.

The transverse or axial direction of the tire is parallel to the axis of rotation of the tire.

The radial direction is a direction that intersects and is perpendicular to the axis of rotation of the tire.

The axis of rotation of the tire is the axis about which it rotates in normal use.

A radial or meridian plane contains the axis of rotation of the tire.

Cycle tires are designed to be used either in a “tube-type” set-up—that is, provided with an inner tube; or in a “tubeless” set-up—that is, mounted on the rim without an inner tube.

In both cases, the function of the bead cores which hold the carcass in position is among other things to grip the rim tightly, either to prevent leaks, in the case of so-called tubeless tires, or in both cases, to keep the tires on the rims during use.

There are also two categories of tire whose appearance depends on the type of bead core.

A first category of tires is made with metal bead cores consisting of a wound metal wire, the number of turns being a function of the size and use of the tire and particularly of its operational pressure. These tires are therefore presented in their final shape, which is a tire forming a torus and therefore take up a lot of space when it comes to transport or storage.

To simplify the storage and transport of cycle tires, a second category of tires which can be folded to limit their space requirements has already been proposed. Such tires are made with bead cores of textile material, such as aramid, and these bead cores can be deformed elastically without affecting their performance when returned to their initial shape. Such tires certainly take up less space and are therefore easier to transport, but their manufacturing costs are higher than the tires of the first category.

It is an object of the invention to provide a bicycle tire that combines the advantages of the tires of both categories presented above—that is, space requirements that can be reduced to facilitate storage and transport of said tire, while the tire can be made with a manufacturing cost similar to that of the tires of the first category.

This object is achieved according to the invention with a bicycle tire comprising a carcass reinforcement, each edge of which is anchored in two beads by a turn-up around a bead core, each bead being continued radially by sidewalls which lead into a tread, each of the bead cores being formed by winding a saturated non-wrapped metal cable made of filaments, the diameter of said cable being less than 1.5 mm and the diameter of the filaments being less than 0.25 mm.

A cable is said to be “saturated” if it is impossible to add an additional filament between the filaments forming said cable. It is said to be “non-wrapped” when it does not have an additional filament wound helically around the outer surface of said cable. A hooping filament is usually chosen with a diameter smaller than that of the filaments of the cable and is wound with a reduced pitch and in an opposite or identical direction to the winding direction of the wires forming the outer surface of the cable. The primary function of a hoop is to limit cable buckling.

The inventors have been able to show that the use of a saturated and non-wrapped metal cable for making the bead cores of the tire, combined with the diameter of the cable and the diameter of the filaments indicated, allows the tires to be deformed and folded without deleterious effects on the bead cores and on their properties which would make the tire unusable.

Thus, the first tests performed on the tires according to the invention showed that it was possible to deform the tires in an exactly similar way to what is currently done with the tires referred to earlier belonging to the second category—that is, made with bead cores of textile material.

The tests have also shown that after the tires have been stored in their folded condition for a period equal to the cumulative periods of transport and average storage time before use on a bicycle, the tires in accordance with the invention recover their initial shape and the properties of the bead cores are not modified.

In a preferred embodiment of the invention, the diameter of the cable is less than 1 mm. Such a cable diameter will in particular make it possible to produce tires in which the dimensions of the bead are identical to those of normal tires, and the cable made according to the invention can have a diameter very similar to that of the wires commonly used.

Also preferably, the diameter of the wires or filaments forming the cable is less than 0.20 mm. Such filament diameters will also contribute to the flexibility of the cable and limit the forces required to fold the tire.

One advantageous embodiment of the invention provides that the modulus in tension of the cable is greater than 150 GPa.

Advantageously also, the cable is pliable to a radius of curvature of between 2 and 5 mm without exhibiting deformation which would render the tire unusable. It is preferably foldable to a radius of curvature of less than 3 mm without exhibiting any deformation which would render the tire unusable.

In a variant of the invention, the cable is a metal cable with construction layers [L+M] or [L+M+N] comprising a first layer C1 with L wires of diameter d₁ with L ranging from 1 to 4, surrounded by at least one intermediate layer C2 with M wires of diameter d₂ wound together helically at a pitch p₂ with M ranging from 3 to 12, said layer C2 being optionally surrounded by an outer layer C3 of N wires of diameter d₃ wound together helically at a pitch p₃ with N ranging from 8 to 20.

When L is 1, the first layer forms a central core consisting of a wire of diameter d₁.

Advantageously in this variant, the pitch p₂ and the pitch p₃ are identical.

Advantageously again in this variant, the cable is a 19.18 metal cable of 1+6+12 construction, the layers being formed with the same direction of rotation and with identical pitches equal to 10 mm. Three to five turns of such a cable allows the formation of a bead core. The number of turns required is a function of the size of the tire and its use.

In another variant, the cable is a 12.15 metal cable of 3+9 construction, the layers being formed with the same direction of rotation and with identical pitches equal to 10 mm. Six to ten turns of such a cable are required to form the bead cores of a bicycle tire depending on the size of the tire.

In one preferred embodiment of the invention, the metal cable is made of steel having a carbon content of less than 0.5%.

The selection of such a steel allows a still greater reduction in the cost price of the cable and therefore the tire. The reason for this is that carbon contents such as this simplify the process of wire-drawing the steel and in particular avoid or at least limit the temperature-raising stages.

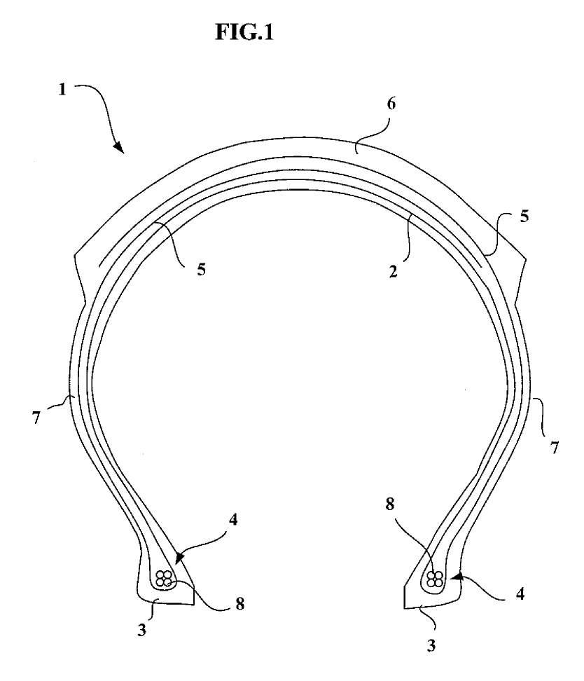

Other advantageous details and features of the invention will be seen below in the description of various illustrative embodiments of the invention, reference being had to FIGS. 1 to 3, which show:

FIG. 1, a meridian view of a diagram of a tire according to the invention,

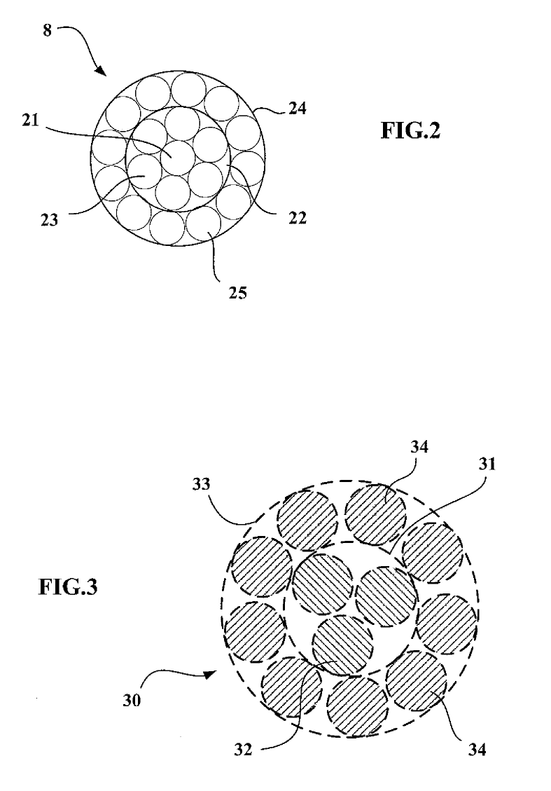

FIG. 2, a schematic cross section through the cable forming the bead core of the tire from FIG. 1,

FIG. 3, a schematic cross section through another cable which may be used to form a bead core for a tire according to the invention.

To make the figures easier to understand, they are not shown to scale.

FIG. 1 shows a type 37-622 tire 1 designed to be fitted to a 622 mm diameter wheel rim for fitting on a “city” style bicycle—that is to say, a bicycle for urban use.

The tire 1 consists of a carcass reinforcing layer 2 anchored in each of the beads 3 of the tire 1 by turning it up around the bead cores 4. The turn-ups 5 of the carcass reinforcing layer 2 extend as far as the crown of the tire, where they overlap. On the crown of the tire, three thicknesses of carcass reinforcing layer 2 may therefore be observed.

Bicycle tires may have other reinforcing element layers at their crown, such as protective layers inserted between the carcass reinforcing layer and its turn-ups. These protective layers may also extend into the sidewalls of the tire as far as the bead cores.

The reinforcement is then radially topped by a tread 6 formed by a layer of rubbery compound which extends to form the sidewalls 7 of the tire 1.

In other embodiments, the rubbery materials from which the tread and sidewalls are made may be different.

In accordance with the invention, the bead cores are formed by winding a type 19.18 metal cable 8, more on which later in reference to FIG. 2. In the case of the size given in FIG. 1 and for the “city” type application, the selected cable has had to be wound through four turns to make each bead core.

FIG. 2 is a schematic cross section through the type 19.18 metal cable 8 forming the bead cores 4 of the tire 1. This is a 1+6+12 construction cable consisting of 19 filaments measuring 18/100 mm. The cable 8 thus consists of a central core formed by a filament 21 surrounded by a first layer 22 made up of 6 filaments 23 which in turn are surrounded by an outer layer 24 made up of 12 filaments 25. The filaments 23 and 25 are wound in the same direction at identical pitches equal to 10 mm. This cable 8 is a saturated non-wrapped cable made of steel with a carbon content equal to 0.4%.

The cable thus defined has a modulus in tension of 190 GPa.

Such a cable can be bent to a radius of 3 mm without permanent deformation which would render the tire unusable.

FIG. 3 is a schematic cross section through a type 12.15 metal cable 30 able to form the bead cores of a tire according to the invention. This is a 3+9 construction cable consisting of 12 filaments measuring 15/100 mm. The cable 30 thus consists of a first layer 31 made of 3 filaments 32 surrounded by a second layer 33 made up of 9 filaments 34. Filaments 32 and 34 are wound in the same direction at identical pitches equal to 10 mm. This cable 30 is a saturated and non-wrapped cable made of steel with a carbon content equal to 0.4%.

The cable thus defined has a modulus in tension equal to 190 GPa.

Such a cable allows folding to a radius of 2 mm without permanent deformation which would render the tire unusable.

The invention should not be interpreted as being limited to the examples given herein. The bead cores may for example be made with other cables provided they meet the defined criteria, or for example with cables whose constructions are identical to those stated at pitches which may be different and/or with the filaments wound in opposite directions.

In addition, the invention applies to all types of bicycles or cycles, such as road cycles, MTBs (mountain bikes), hybrid cycles, cycles with electric or other motorized assistance etc.

The invention also applies to tubeless tires—that is, tires mounted directly on a rim with no inner tube, or to tube-type tires requiring the presence of an inner tube.

1. A bicycle tire comprising a carcass reinforcement, each edge of which is anchored in two beads by a turn-up around a bead core, each bead being continued radially by sidewalls which lead into a tread, wherein each of the bead cores is formed by winding a saturated non-wrapped metal cable made of filaments, wherein the diameter of said cable is less than 1.5 mm and wherein the diameter of the filaments is less than 0.25 mm.

2. The tire according to claim 1, wherein the diameter of the cable is less than 1 mm.

3. The tire according to claim 1, wherein the diameter of the filaments of the cable is less than 0.20 mm.

4. The tire according to claim 1, wherein that the modulus in tension of the cable is greater than 150 GPa.

5. The tire according to claim 1, wherein the cable is foldable to a radius of curvature of between 2 and 5 mm without exhibiting deformation.

6. The tire according to claim 1, wherein the cable is a metal cable with construction layers [L+M] or [L+M+N] comprising a first layer C1 with L wires of diameter d₁ with L ranging from 1 to 4, surrounded by at least one intermediate layer C2 with M wires of diameter d₂ wound together helically at a pitch p₂ with M ranging from 3 to 12, said layer C2 being optionally surrounded by an outer layer C3 of N wires of diameter d₃ wound together helically at a pitch p₃ with N ranging from 8 to 20.

7. The tire according to claim 6, wherein the pitch p₂ and the pitch p₃ are identical.

8. The tire according to claim 1, wherein the cable is a 19.18 metal cable of 1+6+12 construction, the layers being formed with the same direction of rotation and with identical pitches equal to 10 mm.

9. The tire according to claim 1, wherein the cable is a 12.15 metal cable of 3+9 construction, the layers being formed with the same direction of rotation and with identical pitches equal to 10 mm.

10. The tire according to claim 1, wherein the metal cable is made of steel and wherein the steel has a carbon content of less than 0.5%.
